(19) United States
(12) Patent Application Publication
(10) Pub. No.: US 2010/0005944 A1
(43) Pub. Date: Jan. 14, 2010

(54) Compensated adjustable nut for a stringed instrument

(76) Inventors: Orn Eliasson, Ellicott City, MD (US); Paul Eliasson, Ellicott City, MD (US)

Correspondence Address: Paul Eric Eliasson;Om Eliasson, 11711 Foxspur Court, Ellicott City, MD, 21042, US

(21) Appl. No.: 12/218,078

(22) Filed: Jul. 11, 2008

(51) Int. Cl. G10D 3/06

(52) U.S. Cl. 84/314 N

(57) ABSTRACT

A fully adjustable compensated guitar nut is claimed to allow the strings of a guitar to be separately and continuously intonated accurately and easily whenever necessary. The nut employs small adjustable saddles, equal in number to the strings of the instrument. A vertical adjustment screw allows for vertical adjustment of string height (string action) and accommodation of various fingerboard radiuses and a horizontal adjustment screw allows for adjustment of the distance between the nut and the bridge of the instrument, allowing for precise intonation. In addition to vertical adjustment screws, shims can be added under the saddles for further vertical adjustment. This adjustable compensated guitar nut allows for correction of intonation problems related to scale length, string elasticity, string gauge, variation in fret height, variation in guitar action (height of strings above the finger board), as well as finger pressure of the fretting hand (playing style). This system has been tested and has been found to correct intonation not only from the first to the twelfth fret but also from the twelfth fret on up even after complete intonation adjustment of the bridge.

### CROSS REFERENCE TO RELATED APPLICATIONS

### U.S. PATENT DOCUMENTS

| | | | |
|---|---|---|---|
| 2959085 | November 1960 | Porter | 84/314. |
| 4295404 | October 1981 | Smith. | |
| 4464970 | August 1984 | Mischakoff. | |
| 4541320 | September 1985 | Sciuto. | |
| 4696219 | September 1987 | Plescia | 84/314. |
| 4709612 | December 1987 | Wilkinson | 84/314. |
| D302563 | August 1989 | Sirmon et al. | |
| 4852450 | August 1989 | Novak. | |
| 4867031 | September 1989 | Fender. | |
| 5404783 | April 1995 | Feiten et al. | |
| 5481956 | January 1996 | LoJacono et al. | 84/314. |
| 5600079 | February 1997 | Feiten et al. | |
| 5728956 | March 1998 | Feiten et al. | |
| 5750910 | May 1998 | LoJacono. | |
| 5932822 | August 1999 | Bernstein | 84/314. |
| 6433264 | August 2002 | Gimpel et al. | |

### STATEMENT REGARDING FEDERALLY SPONSORED RESEARCH AND DEVELOPMENT

Not applicable.

### REFERENCE TO SEQUENCE LISTING OR TABLE OR COMPUTER PROGRAM LISTING COMPACT DISC APPENDIX

Not applicable.

### BACKGROUND OF THE INVENTION

1. Field of the Invention

The present invention relates to a nut for a stringed musical instrument and, in particular to a compensated adjustable nut for a guitar.

2. Description of Related Art

A standard guitar (FIG. 1) has a body (1A) an elongated neck (1B), a fingerboard (1C), bridge (1D), nut (1E), and a series of frets. The bridge supports the strings on the player's right hand side; the nut supports the strings on the neck of the guitar, at the distal end of the fingerboard on the player's left hand side (assuming a right-handed player).

There are many reasons why a guitar is not in tune. The spacing of the frets on a guitar is equal tempered and the distance between the frets is based on a formula dividing a 12-tone octave into 12 logarhythmically equal parts. Most guitars fail to achieve equal temperament due to incorrect bridge and nut placement. Adjusting the string length at the bridge to improve tuning is called compensating the bridge. In this context, compensation consists of shortening or lengthening individual strings by moving saddles upon which the string rest. The goal of this movement is to improve intonation.

An adjustable bridge is very uncommon on acoustic guitars. Most electric guitars however have adjustable bridge compensation, which allows for better intonation. U.S. Pat. No. 4,541,320, issued to Sciuto, and U.S. Pat. No. 4,867,031, issued to Fender, refer to adjustable bridges where the length of individual strings can be adjusted for improved intonation.

Nut compensation is infrequently seen. U.S. Pat. No. 5,481,956, issued to LoJacono, refers to guitar tuning apparatus with a nut having a plurality of adjustable nut saddle members. Adjustment of the nut determines the length of its string and the longitudinal position of each string. The LoJacono patent involves a complex structure that only allows for horizontal adjustment however.

U.S. Pat. No. 4,295,404, issued to Smith, refers to a compensated nut for a guitar-type instrument. The nut includes an overhang or an extended portion that extends over a portion of the fingerboard. This type of nut does not allow for adjustment, either vertical or horizontal.

U.S. Pat. No. 6,433,264, issued to Gimpel et al., refers to a fixed compensated nut, requiring shortening of the fingerboard and not allowing for horizontal or vertical adjustment.

To summarize, previous designs have not allowed for adjustment of both vertical and horizontal positioning of the strings at the nut. The ability to horizontally and vertically adjustment the nut is highly desirable. This adjustment would improve intonations problems due to variation in string elasticity and gauge, variations in fret height and variations in guitar action (height of strings above the fingerboard).

### BRIEF SUMMARY OF THE INVENTION

The compensated adjustable nut presented is a novel apparatus and a novel method of tuning a stringed instrument such as a guitar. Its use can be applied to electric and acoustic guitars, as well as other stringed instruments. The word guitar will be used to represent all stringed instruments.

The compensated adjustable bridge nut consists of a bracket that is secured to the distal end of the neck of the guitar. A plurality of vertically and horizontally adjustable nut saddles is mounted on the bracket with the horizontal adjustment screw. The number of saddles is equal to the number of strings of the instrument. The bracket is placed at the end of the fingerboard. The compensated adjustable saddles are placed on the bracket. The side of the saddle that faces the bridge (and the fingerboard) has an overhang. This overhang rests above the fingerboard. Once the strings have been placed on the instrument, the vertical adjustment screws allow for variation of the height of the individual strings over the fingerboard and the frets. Furthermore, the configuration of the saddles can be arranged with the vertical screw in a manner to accommodate various finger board radiuses. Additional vertical adjustment can be done by placing thin metal shims under the saddles. The guitar can be tuned, once proper action has been established (proper height of the strings of the fingerboard at the nut). It is recommended to first adjust the bridge saddles in a standard manner so the twelfth fret harmonic is equal to the twelfth fret fretted note. This is done with the nut saddle front end (overhang) in a position corresponding exactly to the end of the fingerboard. Once this has been accomplished, the individual nut saddles can be adjusted. Using a strobe tuner, the open string is tuned first. Each string is then fretted at the first fret. The nut saddle is moved horizontally, either towards or away from the bridge, until the string intonates properly at the first fret. This is repeated for each string of the instrument, resulting in striking improvement of intonation.

The object of the present invention is to provide an apparatus that allows for precise tuning of the instrument. The horizontal and vertical adjustment of the present apparatus allows for precise tuning of the entire fretboard of the guitar. Not only does the present apparatus correct intonation problems from the first to the twelfth fret, but also improves intonation problems above the twelfth fret, even after optimal intonation adjustment (compensation) of the bridge.

Another object of this invention is to provide vertical adjustment for individual strings at the nut. String action (the height of the strings above the fingerboard) affects playability and “feel” of the guitar to a great extent. The vertical adjustment allows for precise vertical movement of individual strings. Conventional nuts require that the string slot be ground or filed to make the changes in action, requiring a permanent alteration of the instrument. The present compensated adjustable nut allows for quick, minute adjustments that can be continuously readjusted until proper action has been established. Furthermore, the vertical adjustment allows for accommodation of various finger board radiuses. The horizontal adjustment screw needs to be loosened a little prior to vertical adjustment. The present adjustable compensated nut allows the capability to play a stringed instrument that is in perfect tune, where fretted notes are in pitch with open string notes and interval intonation is much improved.

The present adjustable compensated nut can be easily installed in new instruments and similarly can be retrofitted on all guitars now in use.

### BRIEF DESCRIPTION OF THE DRAWINGS

FIG. 1 is a schematic representation of a guitar.

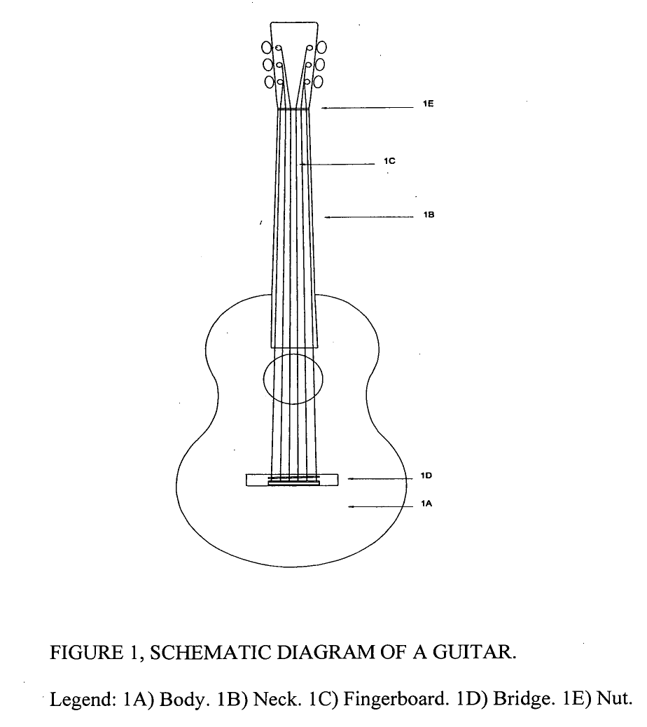

FIG. 2 is a perspective view of the compensated adjustable nut of the present invention showing both the bracket and the saddles positioned at the end of a guitar fingerboard.

FIG. 3 is a perspective view of the bracket.

FIG. 4 is similarly a perspective view of the bracket without its vertical component.

FIG. 5 is a front view of the bracket (as seen from the bridge of the guitar).

FIG. 6 is a top view of the bracket.

FIG. 7 is a perspective view of the saddle.

FIG. 8 is a side view of the bracket and the saddles.

FIG. 9 is a side view of the bracket, without a vertical component and the saddle.

FIG. 10 is a front view (as seen from the bridge of the guitar) of the individual saddles.

FIG. 11 is a top view of the saddle.

FIG. 12 is a top view of a saddle shim.

FIG. 13 is a graph representing the deviation from proper intonation per fret of a standard electric guitar before and after the installation using a standard guitar nut and after the installation of the adjustable compensated nut of the present invention.

### DETAILED DESCRIPTION OF THE INVENTION

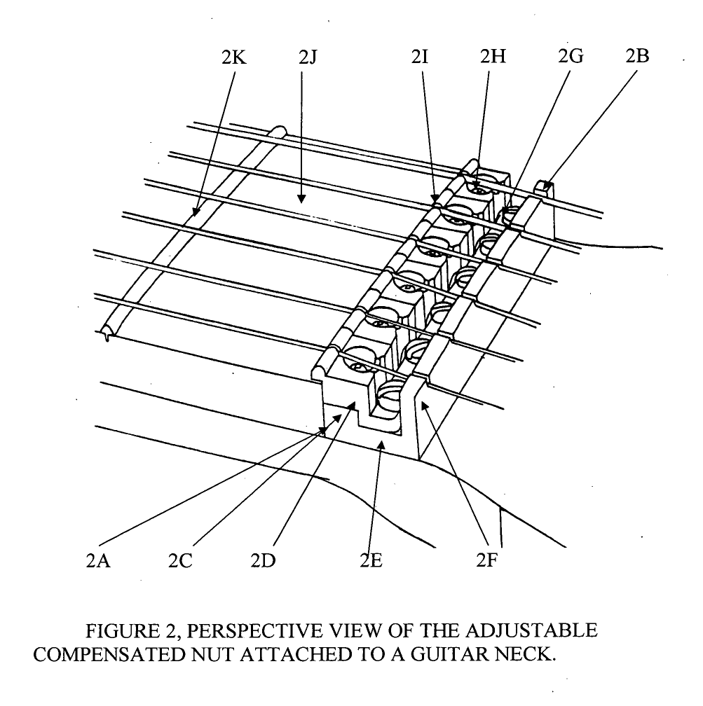

FIG. 2 shows an enlarged perspective view of the adjustable compensated nut of the present invention. This invention replaces the usual nut previously used on guitars. The adjustable compensated nut has an L-shaped bracket (2A) with grooves (2B) of various widths on top of the bracket to accept strings of various gauges. The number of grooves will correspond to the number of strings on the instrument. The bottom of the bracket is secured to the guitar neck with screws. The bottom of the bracket has ridges (2C) on both sides of the saddle (2D) to stabilize the saddle and specifically to prevent any lateral or rotational movement.

The saddles (2D) rest on the horizontal portion (2E) of the bracket, facing its vertical wall (2F). The saddles are attached to the bracket with horizontal adjustment screws (2G). The mid section of the saddle comprises a vertical adjustment screw (2H). The anterior section of the saddle, facing the bridge and the first fret has an overhang (2I) that rests on top of the surface of the fingerboard (2J). This overhang has a groove that corresponds to the gauge of the string for each individual saddle. By loosening the horizontal adjustment screw, the saddle can move horizontally backward or forward (forward toward the bridge and the first fret (2K) or backward away from the bridge and the first fret towards the tuning machines). Once the horizontal adjustment screw has been loosened, vertical adjustment is also possible by turning the vertical adjustment screw. Vertical adjustment can also be accomplished by using a thin metallic shim under the saddle.

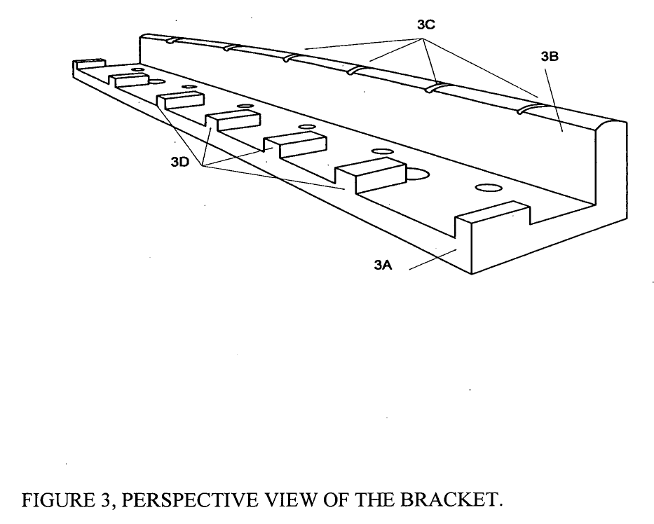

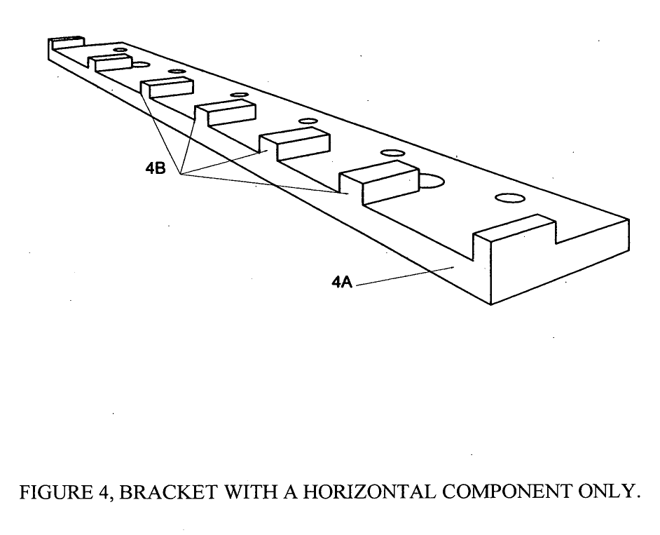

FIG. 3 shows the L-shaped bracket without the saddles. 3A is the horizontal component of the bracket. 3B is the vertical component of the bracket. 3C are the string grooves/slots. 3D are the lateral movement stabilizing ridges. FIG. 4 shows the bracket comprising only a horizontal portion (4A) with its stabilizing ridges (4B), whereas FIG. 3 illustrates both the horizontal (3A) and a vertical (3B) component of the bracket.

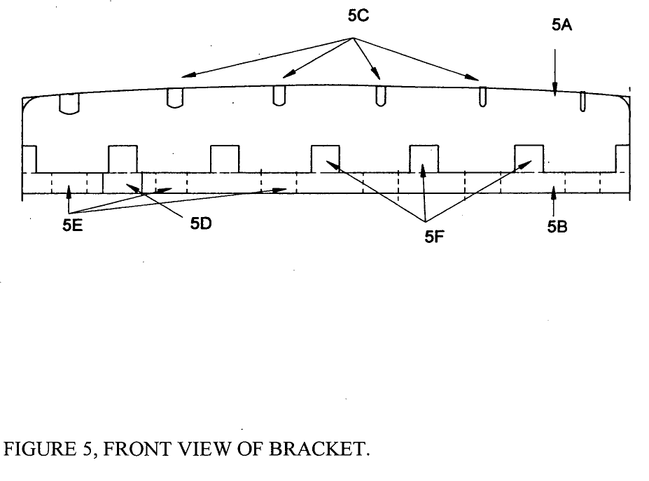

FIG. 5 shows a front view of the bracket (as seen from the first fret and the bridge of the guitar). The bracket has the form of an L with a vertical component (5A) and a horizontal component (5B). On top of the vertical component, there are grooves (5C) of various diameters, corresponding to the strings intended for each specific location. The base or the horizontal part of the bracket has holes to accommodate screws to secure the bracket to the neck (5D), as well as threaded holes (5E) that accept the horizontal adjustment screws of the saddles. The base, or the horizontal segment of the bracket, has ridges (5F) that fit tightly to the sides of the saddle to guard against lateral or rotational movement of the saddles.

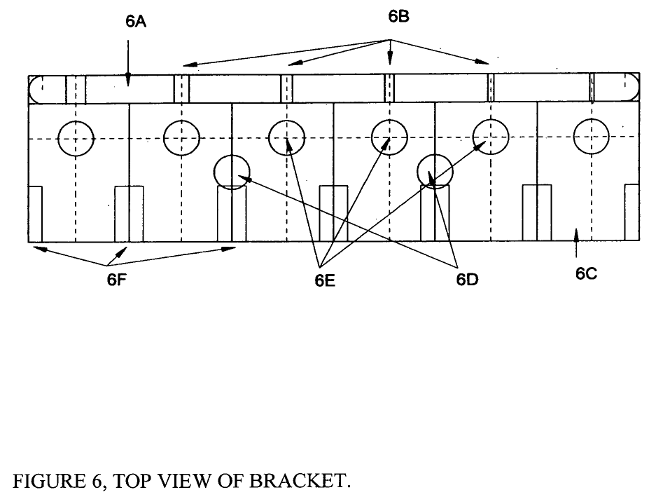

FIG. 6 represents a top view of the bracket. The bracket is L-shaped. The vertical segment (6A), shown on top of the figure, has grooves (6B) to accommodate strings of various gauges. The bottom of the bracket, the horizontal segment (6C), has countersunk holes (6D) to accommodate screws to attach it to the neck of the guitar. The base of the bracket also has threaded holes (6E) that accept the horizontal adjustment screws of the saddle. Finally, the base of the bracket has ridges (6F) anteriorly on the horizontal segment (facing the bridge of the guitar) to guard against lateral movement of the saddle.

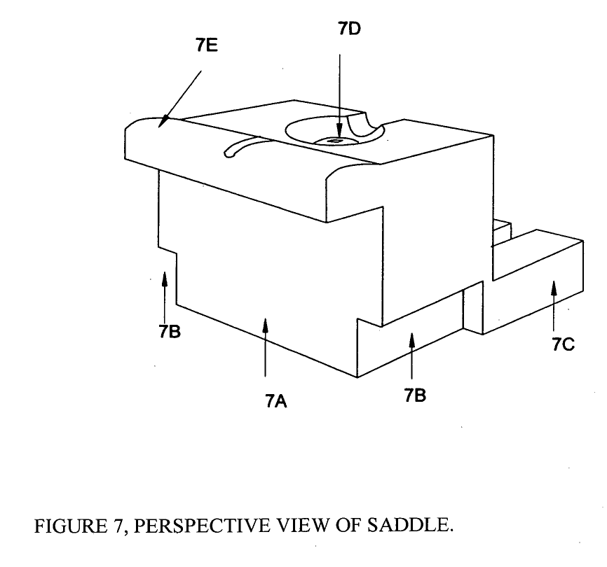

FIG. 7 represents a perspective view of the saddle. The saddle has a main body (7A), cutouts along the sides (7B) matching the ridges on the horizontal portion of the bracket, posterior extensions (7C) that fit around the horizontal adjustment screw, a recessed vertical adjustment screw (7D) as well as an anterior overhang (7E) that overlaps the end of the fingerboard.

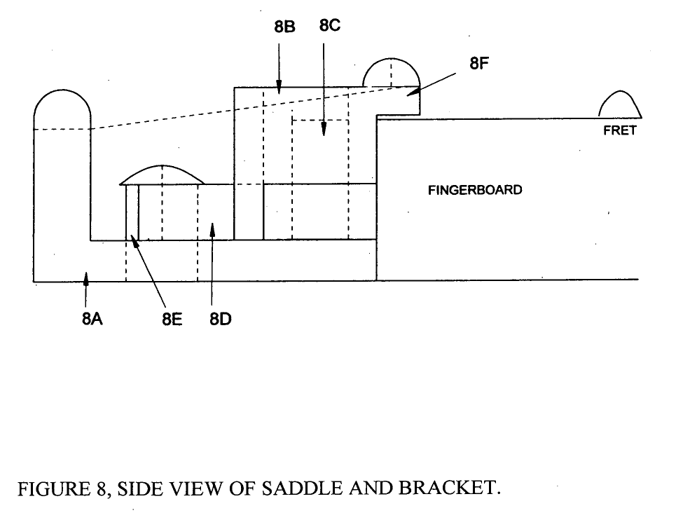

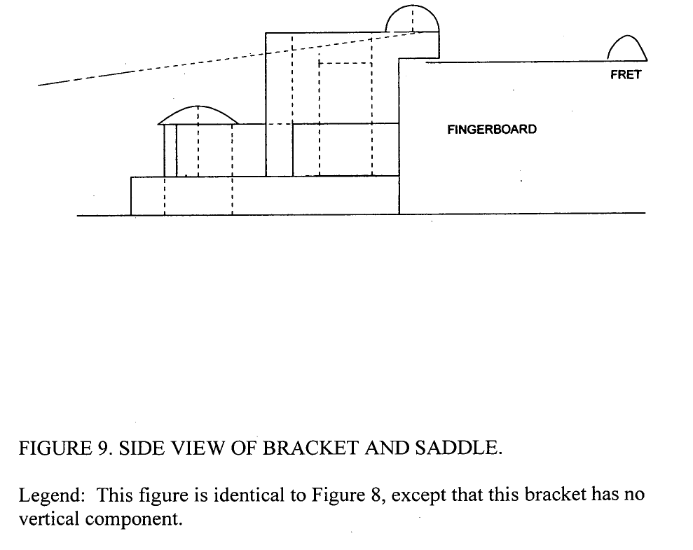

FIG. 8 shows a sideview of the bracket (8A) and saddle (8B). This figure shows the horizontal and vertical components of the L-shaped bracket and the position of the saddle on the bracket. The saddle has a main body that contains the vertical adjustment screw (8C), posterior (facing away from the guitar bridge and facing towards the tuning machines) extensions (8D) that fit around the horizontal adjustment screw (8E), as well as an anterior (facing towards the bridge of the guitar) overhang (8F). The saddle can slide horizontally when the horizontal adjustment screw is loosened. Similarly, the vertical adjustment screw can raise the saddle once the horizontal adjustment screw has been loosened. A shim can be placed under the saddle for further vertical adjustment. FIG. 9 is a similar side view of the bracket and the saddle as the only difference with FIG. 8 is that the bracket has a horizontal component only.

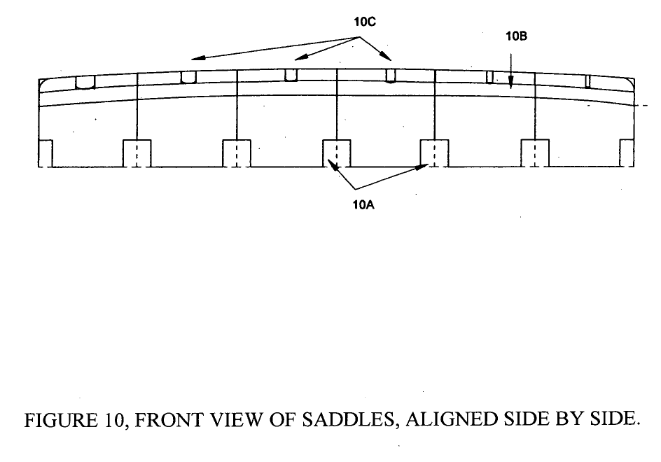

FIG. 10 shows a front view of the various saddles. This view demonstrates the cutout (10A) at the bottom of each saddle to accommodate the lateral motion ridge on the horizontal section of the bracket. The grooves accommodating strings of various gauges are indicated (10C), as well as the overhang (10B).

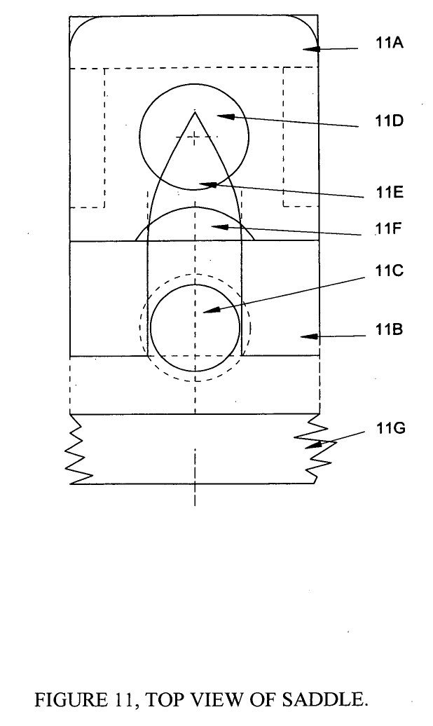

FIG. 11 shows a top view of the saddle and the bracket. The top view of the saddle reveals the anterior (facing towards the bridge of the guitar) overhang (11A), the main body of the saddle, as well as the posterior extensions (11B), fitting around the horizontal adjustment screw (11C). The top view of the saddle shows placement of the vertical adjustment screw (11D); shows the presence of the groove (11E) for the string, as well as cut-out (11F) for head of the horizontal adjustment screw.

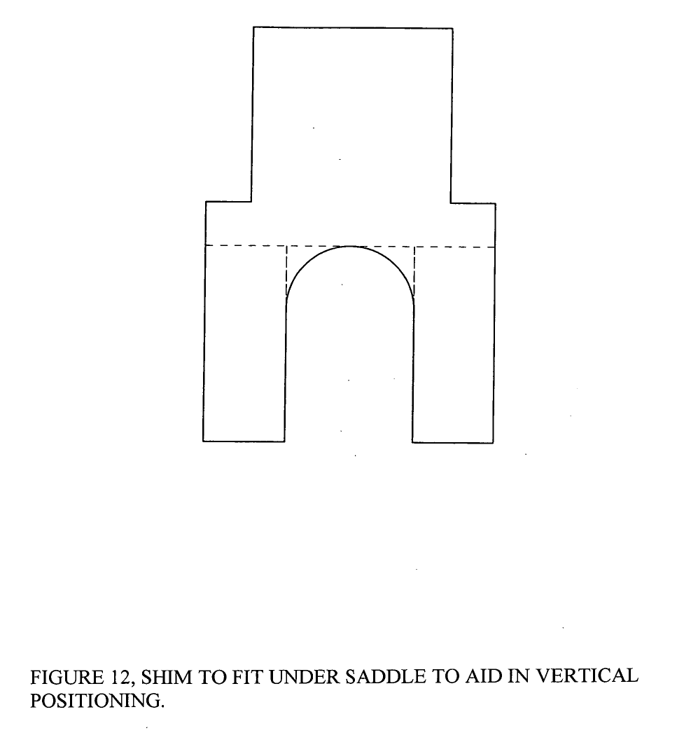

FIG. 12 shows a saddle shim that fits on the bottom of the bracket between the ridges under each individual saddle. The thickness of the saddle shims can vary.

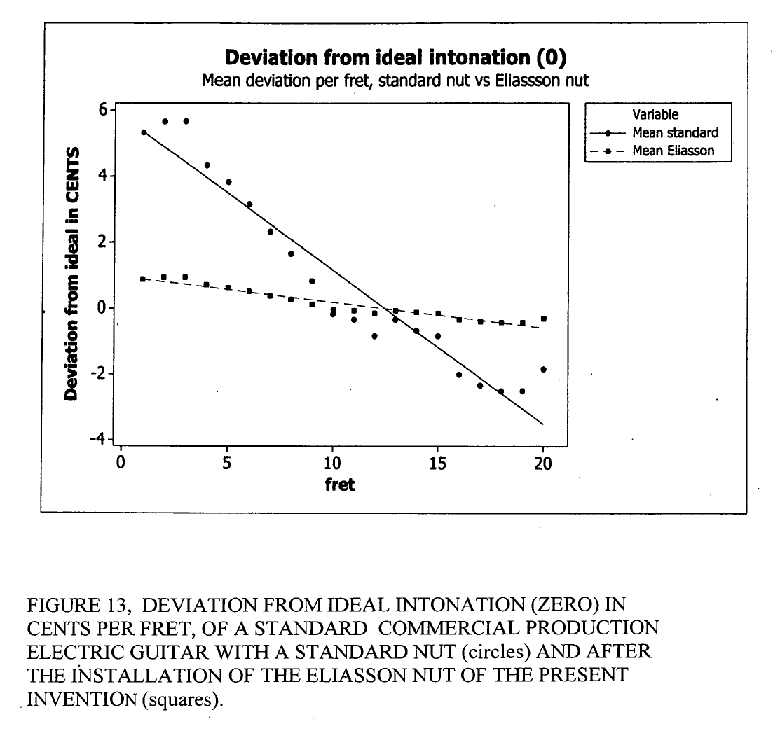

FIG. 13 is a graph showing the deviation from ideal intonation (zero) in cents per fret of a commercial production electric guitar with a standard nut (circles) and the same guitar after the installation of the Eliasson nut of the present invention (squares). Ideal intonation represents zero (0). Each circle and square represent the average (mean) deviation from ideal intonation of all six strings at each fret for each nut, i.e. standard nut (circles) and the Eliasson nut (squares).

What we claim is:

1) An adjustable compensated nut for tuning a guitar comprising a nut bracket in the form of an L to be positioned transversally at the end of the fret board of the guitar. The nut bracket has a base or horizontal section and a wall forming a vertical section. A claim is also made for a bracket that comprises only the horizontal section or the base of the bracket, i.e. a bracket that is not L shaped and does not have a vertical posterior component.

2) A plurality of vertically and horizontally adjusted saddles placed side by side on the base on the horizontal portion of the bracket.

3) A method of individually adjusting saddle's position on the bracket in such a manner that the saddle can be moved horizontally backwards and forwards until the corresponding string is properly intonated. Vertical adjustment to accommodate string action and to match the radius of the fingerboard is also possible by moving the vertical adjustment screw and installing shims under the saddles.

4) The adjustable compensated nut provides means for precise vertical and horizontal location of the saddles for each individual string and once proper intonation has been obtained, the compensated adjustable nut provides for means for firm locking of the position of the saddle by tightening the horizontal adjustment screw.
